(19) United States
(12) Patent Application Publication
(10) Pub. No.: US 2001/0050633 A1
(43) Pub. Date: Dec. 13, 2001

(54) Land based method and apparatus for providing precise time and position (terrestrial alternative of the global positioning system - GPS)

(76) Inventor: Leonard C. Thomas, Newark, CA (US)

Correspondence Address: FENWICK & WEST LLP, TWO PALO ALTO SQUARE, PALO ALTO, CA, 94306, US

(21) Appl. No.: 09/784,989

(22) Filed: Feb. 15, 2001

Related U.S. Application Data
(60) Provisional application No. 60/182,461, filed on Feb. 15, 2000.

(51) Int. Cl. G01S 1/24; G01S 3/02

(52) U.S. Cl. 342/387; 342/464

(57) ABSTRACT

A system and method for providing precise TIME and TIME OF DAY information from the GPS network to mobile receiving units in an efficient and cost effective manner which includes the capability of including reliable real-time position data in cell phones that will meet the FCC requirement of electronic location of 911 calls from cell phones (E9-1-1). The invention operates over a dedicated radio frequency band using two radio channels. Base and Slave Models are used which time share the common radio spectrum. Transmitters are programmed to transmit only in their assigned time slot so as to prevent radio signal interference in any given geographic area.

### RELATED APPLICATION

This application claims the benefit under 35 U.S.C §119(e) of an earlier filed provisional application No. 60/182,461 filed on Feb. 15, 2000, entitled “Cost Effective Method for Distribution of Precise Time”.

### FIELD OF THE INVENTION

The present invention relates to timing in global communications, navigation and location networks. More specifically, the present invention relates to a land based apparatus and method for providing global time and position information on a local basis (or in a larger land area) which represents an alternative to the current Global Positioning System (GPS) satellite network. The invention is intended as a supplement to GPS to extend coverage to areas where the GPS signal is not otherwise available and may be used in a variety of commercial applications including GPS backup for all known commercial applications (in the event of disruption of the GPS signal).

### BACKGROUND OF THE INVENTION

“The time at the tone will be” is a phrase all of us have often heard over the radio. We set our clocks and watches to that tone without giving much thought to the accuracy of the signal or our ability to set the time without introducing considerable error. If plus or minus five seconds is sufficient, using the tone signal is okay. In order to set precision time, however, one would need to take into consideration:

a) the time that it took for the signal to travel from the tone generator to the radio transmitter site,

b) the time that it took the radio signal to travel from the transmitter site to our radio receiver,

c) the time for the sound to travel from the radio speaker to our ear and,

d) our reaction time.

For the purposes of this paper, precision time will be measured in nanoseconds, that is in billionths of a second (1/1,000,000,000 second) and distance will be measured by the time that it takes an RF (radio frequency) signal to travel from one point to the next (about one foot per nanosecond).

By international agreement, “time” has been defined as:

“The second is the duration of 9,192,631,770 periods of the radiation corresponding to the transition between the two hyperfine levels of the ground state of the cesium 133 atom.”

Devices that generate this precise time signal are referred to as Atomic Clocks, Cesium Standards or Primary Reference Sources. Simply stated, these time devices are heavy, fussy, expensive, and have no hands or digital displays. They only generate the precise time interval of one second. Time of day is another matter.

Two definitions are needed at this point and they must be understood and remembered for the subject matter that follows:

1. TIME: the duration—as defined above. It is only a rate or one divided by the frequency (1/f).

2. TlME-OF-DAY: the time measured from midnight or some other reference. Time-of-day depends on the time zone and is subject to adjustment twice each year. The body that administers time, the Bureau International de l'Heure in Paris votes on the admission or rejection of a leap second twice each year (June 30 and December 31).

Global telephone transmission (optical fiber) and communications networks, including the Internet, are highly dependent upon intricate digital switching networks, which must operate at precise moments in time. Time, by itself, was traditionally sufficient for the synchronization of these telephone transmission and communications networks and time-of-day was not critical, at least time-of-day measured in small fractions of a second. Therefore stand-alone atomic clocks were traditionally used to synchronize the switching and multiplexing elements in massive telephone networks such as the SPRINT digital SONET (Synchronous Optical NETwork) long distance telephone system. However, these devices were expensive and difficult to maintain, plus the radioactive cesium source in the atomic clock required replacement about once every five years.

The advent of the Global Positioning System (GPS) changed all of that. With the time reference delivered from space, the industry now had what is referred to as Common View Synchronization. That is, all of the precision time receivers in a large geographic area could receive their precision time signal from a common satellite or group of satellites. If the distance from the common source could be determined with precision, precise TIME and precise TIME-OF-Day could be delivered on a continuous basis.

FIG. 1 illustrates the GPS system. GPS is a constellation of twenty-four satellites, eighteen active, and six ready spares that orbit the earth in polar, equatorial, and diagonal orbits. FIG. 1 illustrates 3 GPS satellites and two ground receiving units. GPS provides signal coverage suited for both naval and airborne navigation. The sole function of the twenty-four satellites that makeup the GPS network is the distribution of precise TIME and precise TIME OF DAY. Various receiving devices use this time information to provide network synchronization, location, and navigation. The GPS network also includes earth based performance monitoring stations that constantly measure the TIME signals from each satellite as each satellite passes over the US controlled site. These monitoring stations then send the corrections back to the individual satellite if and when necessary.

The reception and setting of precise TIME OF DAY in a land-based receiver depends on knowing the exact distance from the time source (one or more GPS satellites) to the earth based receiver to the nearest foot or less. Accuracy of location and time are achieved by averaging a large number of samples from multiple satellites. The time to achieve the desired result (accuracy) may be on the order of twenty-four hours, but once achieved, it is easily maintained, provided the location of the receiving device does not change.

Hyperbolic Navigation

Using Hyperbolic Navigation, location of any point on a surface can be determined by measuring a signal travel time from three different known fixed locations, if the velocity of the signal is known and the signal travels by way of a direct path (line-of-sight). FIG. 2 illustrates the concept of Hyperbolic Navigation. Using Hyperbolic Navigation, the location of a point on a surface can be determined if the difference in the distances from at least three fixed locations to the unknown location is measured. This can be done by measuring the time delay for a signal to travel from each of the three known locations to the unknown location. Accordingly, Hyperbolic Navigation permits the determination of location of a portable device without the need for a precise TIME or TIME OF DAY clock in the portable device. In this case, the precise TIME OF DAY must be known at the three fixed points, but only relative time is needed at the location in question. Again the signal travel must be via a line-of-sight path.

GPS and Global Positioning

GPS does not use Hyperbolic Navigation for determining Global Positioning. Instead, GPS uses a pseudo ranging technique for determining global position. The specifics for the implementation of this technique in GPS are highly classified.

Limitations of GPS

At present, there is no backup system for GPS. Failure or deliberate jamming of the GPS signal would cripple the nation. It is not possible to revert back to the old analog microwave radio systems for voice, or data transmission since these networks no longer exist (and if they did, they would not be able to provide the voice and data traffic volume or the quality of service that we have come to enjoy). Except for the analog cell phones, all PCS phones and digital cell phones depend on GPS timing. Further, the analog cell phones would be of no use since the cell phone provider's digital telephone switches would be out of service.

Moreover, when using GPS, precise TIME and TIME OF DAY can be acquired and maintained at fixed locations provided that these locations have a clear view of the sky that permits the reception of signals from multiple GPS satellites at the same time. In order to determine accurate position using GPS, signals must be received from a minimum of three satellites (four if elevation information is also required). Therefore, signal reception for determining position requires approximately a 120° unobstructed view of the sky. Accordingly, GPS will not work in buildings or areas with high-rise building or heavy foliage, such as forests. Additionally, because GPS signal are required to travel such great distances, they require large amounts of power to generate and are often very weak by the time they reach their intended location on the surface of the earth.

Accordingly, what is needed is a way for providing accurate TIME and TIME OF DAY and determining position within all areas, including inside buildings and areas of heavy foliage, such as forests. What is further needed is a means for doing so which does not require as much power in the receiving equipment when used in light weight portable receivers such as in cell phones. What is further needed is a system that operates in a much lower frequency band in order to permit signal penetration of buildings and lower cost receivers. What is further needed is a system that provides very efficient utilization of the limited radio frequency spectrum that is available for these applications. What is further needed is a system for determining TIME, TIME OF DAY and geographic position that is more accurate, i.e. accurate to within several nanoseconds and a few feet.

### SUMMARY OF THE INVENTION

The invention includes a system and method for providing precise TIME and TIME OF DAY information from the GPS network to mobile receiving units in an efficient and cost effective manner. Moreover, the invention provides the capability of including reliable real-time position data in cell phones that will meet the FCC requirement of electronic location of 911 calls from cell phones (E9-1-1).

In a preferred embodiment, the system of the present invention will be used with mobile receiving units which will preferably be implemented in digital cell phones with wireless Internet access or personal digital assistants (PDA's) having features similar to the 3Com Palm Pilot. Using the present invention, it is possible to determine the location of a mobile receiving unit and then have local maps and directions downloaded to a user in real time, thereby providing information that can direct the user from his or her present location to a desired location or simply providing compass directions and distance to the desired location. These features are available without requiring any active internet or network connection and the location data may be forwarded to any designated control center when directions or location is needed. In the case of E9-1-1, location data would be forwarded to a Public Safety Answering Point (PSAP) automatically with each 911 call.

In a preferred embodiment, the invention will operate in a single dedicated radio frequency band using two radio channels and time-share the common radio spectrum. Transmitters are programmed to transmit only in their assigned time slot so as to prevent radio signal interference in any given geographic area.

### BRIEF DESCRIPTION OF THE DRAWINGS

FIG. 1 illustrates a GPS system;

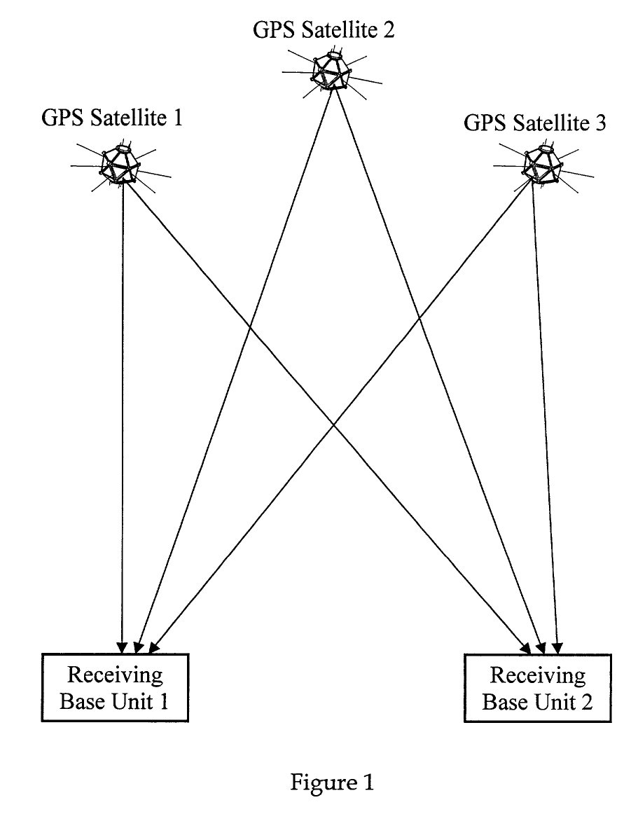

FIG. 2 illustrates the concept of Hyperbolic Navigation;

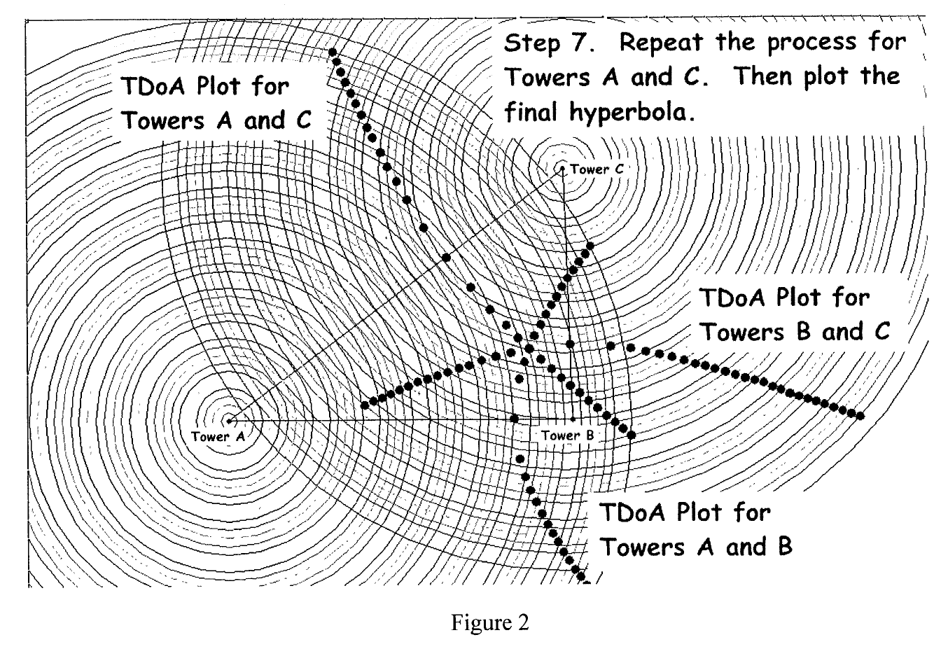

FIG. 3 illustrates a preferred embodiment of a system for distributing accurate time and time of day and determining position of mobile receiving units;

FIG. 4 illustrates a preferred embodiment of a Base Model;

FIG. 5 illustrates a preferred embodiment of a Slave Model;

FIG. 6 illustrates the two RF carrier signals generated by the Base and Slave Models in accordance with a preferred embodiment of the present invention;

FIG. 7 illustrates the steps involved in determining the exact geographic location of a mobile receiving unit;

FIG. 8 illustrates a preferred embodiment of a receiving unit.

### DETAILED DESCRIPTION OF THE INVENTION

Precise three-dimensional location and navigation are made possible when a receiving device is able to determine the time difference of arrival of signals from four or more sources with known locations. When more than four such sources are available, assurance of correct data is possible. However GPS will only work provided that the receiving location has a clear view of the sky that permits the reception of signals from multiple GPS satellites at the same time. In order to assure accurate three-dimensional position using GPS, signals must be received from a minimum of five satellites. Therefore, signal reception for determining three-dimensional geographic position requires approximately a 120° unobstructed view of the sky. Accordingly, GPS will not work in buildings or areas with high rise buildings or heavy foliage, such as forests.

The invention is for a system and method that receives precise TIME interval and TIME OF DAY information from the GPS network and then distributes that information locally to any number of terrestrial based mobile receiving units and in a cost effective manner. Moreover, the invention provides reliable real-time position data to receiving units implemented in cell phones that will meet the FCC requirement of electronic location of 911 calls from cell phones (E9-1-1). It invention also enables a host of new services ranging from aiding delivery services, the location of missing or stolen vehicles, location of key personnel, public safety and field personnel and vehicles, as well as user defined locations, such as where ones car was last parked at the airport or ball park.

In a preferred embodiment, the system of the present invention includes transmitting units or models (Base and Slave) for distributing accurate TIME and TIME OF DAY information to any number of mobile receiving units which are preferably implemented in digital cell phones with Internet access or PDA's having features similar to the 3Com Palm Pilot. Using the present invention in conjunction with wireless internet data access, it will be possible to determine the user's location and then have local maps and directions downloaded to the user in real time providing information that can direct the user from their present location to a desired location or simply provide compass direction and distance to the desired location.

In a preferred embodiment, the invention will operate over a single dedicated radio frequency band using no more than two radio channels and by time sharing of these radio channels, using transmitters which are programmed to transmit only in their assigned time slot, effectively utilize the limited radio frequency spectrum.

System Overview

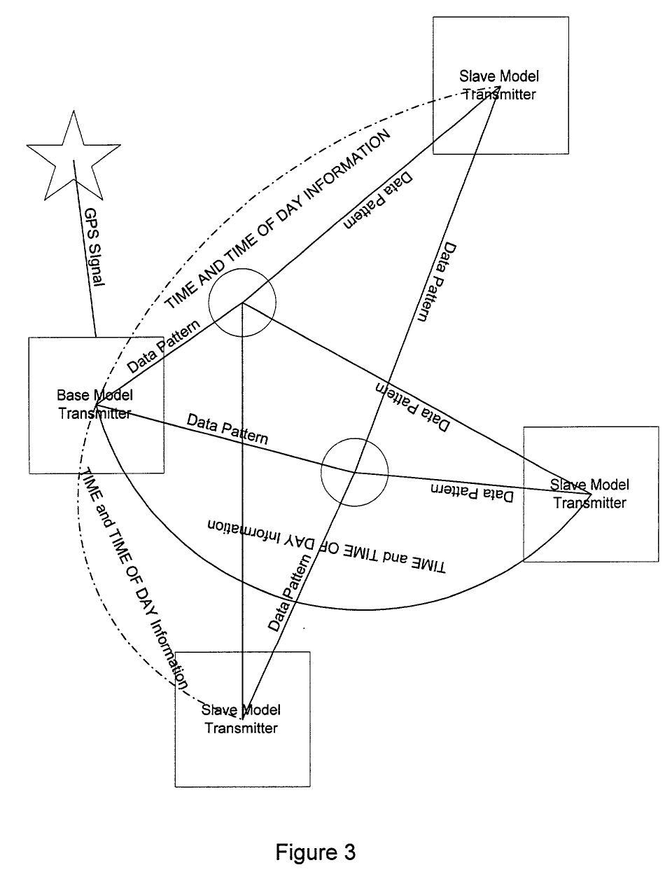

FIG. 3 illustrates a preferred embodiment of system for distributing accurate time and time of day and determining position of mobile receiving units. As shown, the system preferably consists of two different models of time/data distribution transmitters and any number of mobile receiving units, which may be cellular telephones, personal digital assistants (PDA's) or similar devices such as the Palm Pilot. The two different models of time/data distribution transmitters are referred to as a Base Model and a Slave Model. Both models are ground based transmitters that are positioned at fixed locations. The time/data distribution transmitters will transmit signals to the mobile receiving units implemented in various hand held devices, such as cellular phones and/or personal digital assistance modules (PDA's).

In a preferred embodiment, the Base Models receive accurate time and time of day information from multiple GPS satellites and transmit that information to the various Slave Models in order to calibrate the internal clocks within the Slave Models. Both the Base and Slave Models transmit data signals to the mobile receiving units.

Base Models

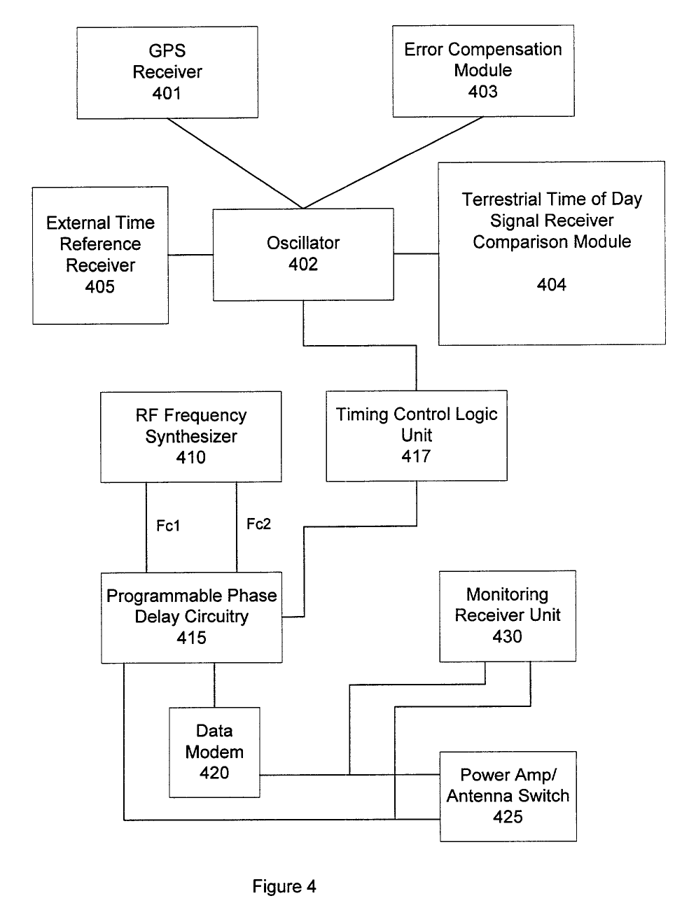

FIG. 4 illustrates a preferred embodiment of a Base Model. The function of the Base Model is to receive precise TIME AND TIME OF DAY information from a GPS receiver at a fixed location. And then to retransmit that information in a dedicated frequency band and unique time slot so as to provide the equivalent of a GPS signal in a local terrestrial area, including areas where GPS coverage is not otherwise available or reliable, such as is found between and inside large buildings or under heavy foliage. The Base Model will also be used to provide one of the necessary three or four (if elevation is required) source locations needed for determining the geographic location of a mobile receiving unit.

In a preferred embodiment, the Base Model includes a GPS receiver 401 which receives a GPS signal from a GPS antenna for receiving accurate TIME and TIME OF DAY information from a GPS satellite. The Base Unit is also equipped with a precision oscillator (rubidium or equivalent) 402 which generates an internal TIME OF DAY clock signal that is disciplined by the GPS signal, in order to correct for errors that may be introduced into the system by atmospheric conditions or radio frequency interference (including deliberate jamming of the GPS signal).

In a preferred embodiment, the Base Model also includes an Error Compensation Module 403 which includes software instructions for accounting for delays in receiving the GPS signal and the internal TIME OF DAY clock signal which is transmitted out to Slave Models. This process shall be described further hereinafter.

Optionally, the Base Model includes a Terrestrial Time of Day Signal Receiver and Comparison Module 404 which allows the Base Model to receive TIME OF DAY signals from other Base Models within a predetermined distance of up to XXX miles and compare these signals with its own internal TIME OF DAY clock signal generated by the precision oscillator in order to calibrate its own internal TIME OF DAY clock signal if GPS should become unavailable. The Base Model will also optionally include an External Time Reference Receiver 405 which can receive a TIME input signal from an external clock source, such as a cesium clock or LORAN-C receiver coupled with a disciplined frequency standard, in order to calibrate its own precision oscillator.

The Base Model also includes an RF Frequency Synthesizer 410 for generating two different RF carrier signals. In a preferred embodiment, one carrier signal has a frequency of 114 MHz and the second RF carrier signal has a frequency of 116 MHz. At these frequencies, these two signals will be in phase every 250 nanoseconds. It is understood that alternative embodiments with alternative RF frequencies are envisioned and covered. The Base Model further includes Phase Delay circuitry 415 which is coupled to the RF Frequency Synthesizer and designed to introduce additional phase delay between the two RF carrier signals. It is this phase delay which is used at a mobile receiver to determine and record the time at which the two carrier signals are received and calculate transmission times in order to determine global position of the mobile receiving unit. The Base Unit includes a Timing Control Logic Unit 417 which determines and controls the time at which the phase shift is introduced between the two RF carrier signals. The time interval at which it is introduced is constant and is preprogrammed into the Base Model. The Timing Control Logic Unit 417 is coupled between the oscillator and the RF frequency Synthesizer. This process shall be described in further depth hereinafter.

The Base Model is also equipped with a Data Modem 420 which is coupled to the Phase Delay circuitry 415 and which generates a seventeen byte digital data pattern. The content of the digital data pattern shall be described further hereinafter; but, includes the exact TIME OF DAY at which the phase difference between the two RF carrier signals was introduced into the signals. The data pattern is then converted by the Modem 420 from a digital signal to an analog signal and is mixed with one of the two RF carrier signals.

In a preferred embodiment, the Base Model also includes a Power Amp/Antenna Switch 425 which is coupled between the Data Modem 420 and a plurality of antenna systems (not shown). The system of the present invention is configured to utilize pre-existing antenna systems. The Power Amp/Antenna Switch 425 boosts the two RF carrier signals and provides them to each antenna system in the plurality so the RF signals can be transmitted to a plurality of mobile receiving units at the same time.

Finally, in a preferred embodiment, the Base Unit will also be equipped with a Monitoring Receiver Unit 430 which provides remote control and internal performance monitoring of the Base Model and ensures accurate operation of the Model.

The operation of the Base Unit will be described by defining the signals that are programmed during installation, the signals that it receives from other sources (A and C. above) and the signals that it transmits (B and D above).

1) Data input at the time of installation:

a) Latitude and Longitude provided by the GPS receiver,

b) Transmitter identification code,

c) Assigned time to begin transmission and,

d) Time interval between transmissions.

2) Continuous input data from the GPS receiver (“A” in the above sketch):

a) Precise time-of-day averaged by the GPS receiver oscillator.

3) Input data from the Data Communications link (“C” in the above sketch):

a) Enable/disable transmission (if required),

b) Time correction data—this will be needed to assure that the synchronizing pulse coincides with the encoded time-of-day that is transmitted.

c) Interrogation from the control center (status check)

d) Monitor the time that is reported by all other Time Distribution Units in the receiving area. This represents a key element in the self calibration and automatic maintenance of the described system.

4) Output data to the Data Communications link (“B” in the above sketch):

a) Alarms and error messages

b) Response to status check.

5) Output data to the transmitter (“D” in the above sketch):

a) Start of transmission code

b) Transmitter identification code

c) Time-of-day code

d) Transmitter location (Lat. & Long.)

e) Synchronizing pattern

f) Cyclic Redundancy Code (CRC)—data transmission error check.

The GPS receiver in the Base Model acquires a precise time of day signal from each GPS satellite that is in its view. From these satellites, the GPS receiver determines its exact fixed location and the exact TIME OF DAY at its location including error introduced by selective availability (currently discontinued). The location determined is then stored in the Base Model. The Base Model uses the GPS signal to calibrate its internal oscillator and adjust the TIME OF DAY signal generated by the oscillator. As explained earlier, the Base Model also includes an Error Compensation Module 403 which includes software instructions for accounting for delays in receiving the GPS signal, these delays include delay and timing for transmission from the remote GPS satellite installation where the GPS signal is received to the actual GPS receiver in the Base Model.

In operation, as will be described further herein, the Base Model transmits its identification code, its location, and the precise time of day in a predefined time slot and at a predefined time interval. The Error Compensation Module 403 will also include software instructions for accounting for delays and timing in transmitting the two RF carrier signals out to the antenna systems for broadcast to the mobile receiving units, these delays include delay and timing for transmission from the Base Model to the satellite installation where the two RF carrier signals are transmitted for broadcast to the mobile receiving units.

Each Base Model preferably has a number of Slave Models with which it is associated and which together form a cell. The Base model transmits time of day information at regular time intervals to all of the other slave models in the cell using a high power level signal which is transmitted over a dedicated RF frequency band. In a preferred embodiment, the Base Model is co-located with a cell phone base station or tower. Accordingly, the power level of signals transmitted from the Base Model would be comparable (probably somewhat higher in order to provide better coverage) to that of cell phone signals transmitted from the cell phone base station or tower. The Base Model will also include a receiver that will receive a time reference signal from each Slave Model and use that signal to calculate the time offset needed to calibrate the Slave Model's internal time of day clock.

Slave Models

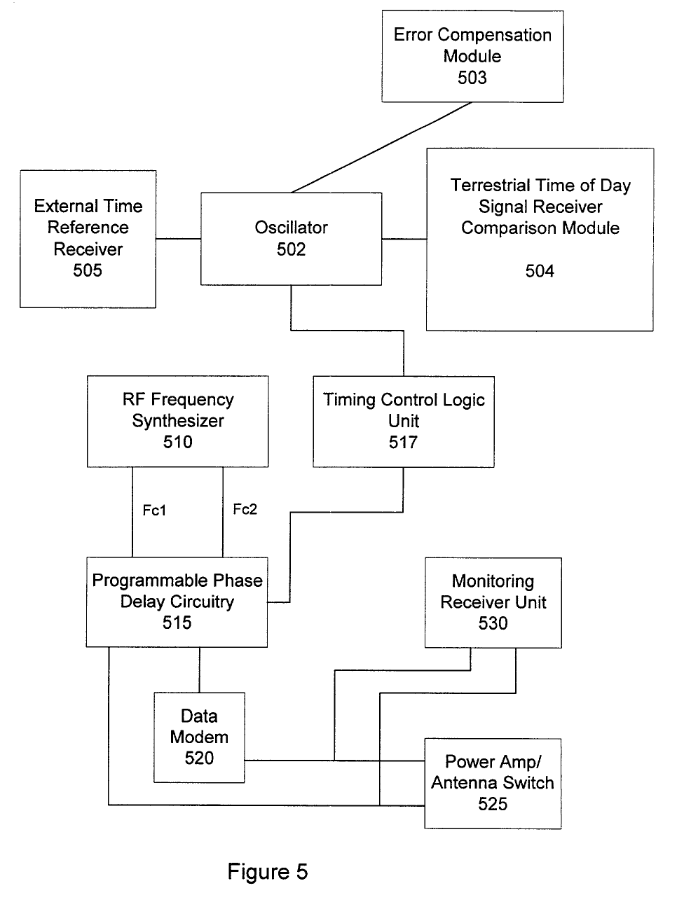

FIG. 5 illustrates a preferred embodiment of a Slave Model. In a preferred embodiment a Slave Model is almost identical to a Base Model, except that it does not include a GPS receiver. Instead, a Slave Model receives TIME OF DAY signals from a Base Model within a predetermined distance of up to XXX miles and compares the signal with its own internal TIME OF DAY clock signal generated by a precision oscillator 502 within the Slave Model in order to calibrate its own internal TIME OF DAY clock signal. Accordingly, as is shown in FIG. 5, the Slave Model is equipped with a precision oscillator (rubidium or equivalent) 502 which generates an internal TIME OF DAY clock signal that is disciplined by a TIME OF DAY signal received from a Base Model in the same cell as the Slave Model, in order to correct for errors that may be introduced into the system by atmospheric conditions or radio frequency interference.

In a preferred embodiment, the Slave Model also includes an Error Compensation Module 503 which includes software instructions for accounting for delays in receiving the TIME OF DAY SIGNAL transmitted out to Slave Models from the Base Model in the same cell. This process shall be described further hereinafter.

The Slave Model receives the TIME and TIME OF DAY information from a Base Model through a Terrestrial Time of Day Signal Receiver and Comparison Module 404 which allows the Slave Model to receive TIME and TIME OF DAY information from multiple Base Models within a predetermined distance of up to XXX miles and compare these signals with its own internal TIME OF DAY clock signal generated by the precision oscillator 502 in order to calibrate its own internal TIME OF DAY clock signal. Accordingly, instead of receiving TIME and TIME OF DAY information from GPS, a Slave Model receives this information from a ground based Base Model. Optionally, a Slave Model may also include an External Time Reference Receiver 505 which can receive a TIME input signal from an external clock source, such as a cesium clock or a LORAN-C receiver coupled with a disciplined oscillator, in order to calibrate its own precision oscillator.

Much like the Base Model, the Slave Model also preferably includes an RF Frequency Synthesizer 510 for generating two different RF carrier signals. In a preferred embodiment, one carrier signal has a frequency of 114 MHz and the second RF carrier signal has a frequency of 116 MHz. At these frequencies, these two signals will be in phase every 250 nanoseconds. It is understood that alternative embodiments with alternative RF frequencies are envisioned and covered. The Slave Model further includes Phase Delay circuitry 515 which is coupled to the RF Frequency Synthizer and designed to introduce additional phase delay between the two RF carrier signals. As explained earlier, it is this phase delay which is used at a mobile receiver to determine and record the time at which the two carrier signals are received and calculate transmission times in order to determine global position of the mobile receiving unit. The Slave Unit also includes a Timing Control Logic Unit 517 which determines and controls the time at which the phase shift is introduced between the two RF carrier signals. The time interval at which it is introduced is constant and is preprogrammed into the Slave Model. This time will be slightly offset from the time at which a Base Model in the cell transmits its two RF carrier signals. Accordingly, a Base Model within a cell will transmit first, the each Slave Model in the cell will transmit in turn, one after the other. The Timing Control Logic Unit 517 is coupled between the oscillator and the RF frequency Synthesizer.

The Slave Model is also equipped with a Data Modem 520 which is coupled to the Phase Delay circuitry 515 and which generates a seventeen byte digital data pattern. The content of the digital data pattern shall be described further hereinafter; but, includes the exact TIME OF DAY at which the phase difference between the two RF carrier signals was introduced into the signals. The data pattern is then converted by the Modem 520 from a digital signal to an analog signal and is mixed with one of the two RF carrier signals.

In a preferred embodiment, the Slave Model also includes a Power Amp/Antenna Switch 525 which is coupled between the Data Modem 520 and a plurality of antenna systems (not shown). The system of the present invention is configured to utilize pre-existing antenna systems. The Power Amp/Antenna Switch 525 boosts the two RF carrier signals and provides them to each antenna system in the plurality so the RF signals can be transmitted to a plurality of mobile receiving units at the same time.

The function of a Slave Model is to receive precise TIME OF DAY information from one or more adjacent Base Models and to retransmit that information in a dedicated frequency band and unique time slot to mobile receiving units such that the mobile receiving unit can calculate its exact geographic position. This will provide the equivalent of a GPS signal in areas where GPS coverage is not otherwise available or reliable, such as is found between and inside large buildings, etc. Accordingly, the function and operation of the Slave Model is identical to that of the Base Model except that the source of timing information is from one or more Base Models rather than from the GPS satellites directly.

The precise location of the Slave Model must be calculated and input manually at the time of installation. In a preferred embodiment, Slave Models are equipped with a remote control to disable the transmitter via a wired or wireless data communications facility that is connected to each Base Model or Slave model.

The operation of the Slave Model will be described by defining the signals that are programmed during installation, the signals that it receives from other sources (C above) and the signals that it transmits (B and D above).

1) Data input at the time of installation:

a) The calculated Latitude and Longitude,

b) Transmitter identification code,

c) Assigned time to begin transmission, and

d) Time interval between transmissions.

2) Input time-of-day from one or more adjacent Base Models (“D” in the above sketch):

3) Input data from the Cell Phone Recover (“C” in the above sketch):

a) Enable/disable transmission (if required),

b) Time correction data—this will be needed to assure that the synchronizing pulse coincides with the encoded time-of-day that is transmitted.

c) Interrogation from the control center (status check)

d) Monitor the time that is reported by all other Time Distribution Units in the receiving area. This represents a key element in the self-calibration and automatic maintenance of the described system. This time-of-day input may be received from line “D” in the sketch.

4) Output data to the Cell Phone Transmitter (“B” is the above sketch):

a) Alarms and error messages

b) Response to status check.

5) Output data to the transmitter (“D” in the above sketch):

a) Start of transmission code

b) Transmitter identification code

c) Time-of-day code

d) Transmitter location (Lat. & Long.)

e) Synchronizing pattern

f) Cyclic Redundancy Code (CRC)—data transmission error check.

Both models (Base and Slave) will include a data communications link to a control center to be used for status, alarm and remote control functions. In a preferred embodiment, all receiving units such as cell phones and PDA's will operate with communication access to multiple Base Model units or a combination of Base model units and Slave model units (when needed) in order to receive accurate time of day information.

Three dimensional geographic position information depends on access to four and preferably more than four transmission models at any one time. Accordingly, it is preferable that there be at least four Base or Slave Models deployed for each cell area where location coverage is desired. The transmission power level for the Slave Model will preferably be the same as that used for the Base Model. Although, in an alternative embodiment the transmission power level for a Slave Model may be lower than that used for the Base Model.

In a preferred embodiment, the network operates by having a Base Model transmit its signal at a pre-defined (programmable) time. This transmission is then followed by transmissions from each of the adjacent Base or Slave Models that are located within the same cell zone as the Base Model.

Base Models and Slave Models that are located in adjacent cells, or in a geographic area that could interfere with another Base Model would be programmed to transmit in a different time slot, therefore eliminating the system interference at the receiving unit. In a preferred embodiment where cells are sufficiently separated to assure non-interference of radio signals, time assignments may be reused. All of the transmission units are positioned at fixed locations and calibrated to operate from these fixed locations. Relocation of any one unit would require recalibration in order to ensure accurate time of day measurements.

The functions of all Base Models are the same. Base Models will receive a time reference signal form the GPS network or from one or more adjacent Base Model Units. Base Models each have a transmitter identification code, a time of day correction factor (where and when needed), a time of day and time interval for Start of Transmission, and a set control to enable or disable transmission. In a preferred embodiment, this data is password protected.

Data Signals Provided to Receiving Units for Determining Position

As explained above, the Base and Slave Models transmit two RF carrier signals, one of which contains data relevant to the transmission. A phase difference is introduced into the two signals in order to mark the timing of a new transmission and provide synchronization at the transmit and receive ends.

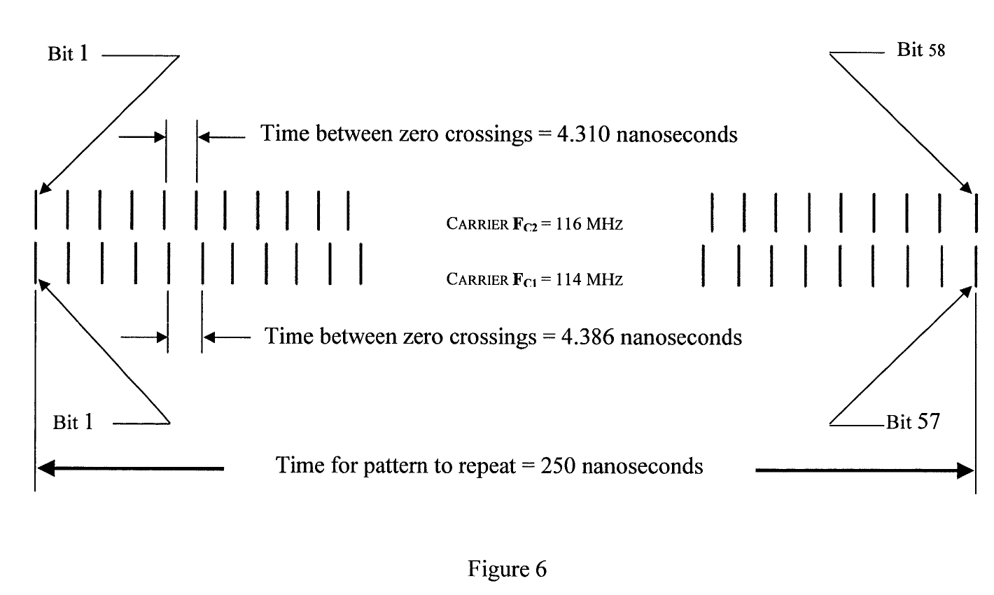

FIG. 6 illustrates the two RF carrier signals generated by the Base and Slave Models in accordance with a preferred embodiment of the present invention. As shown, there are two RF carrier signals Fc1 and Fc2. The diagram shows lines representing zero crossings for each signal. In a preferred embodiment, the signals are transmitted at 116 MHz and 114 MHz, respectively, such that they will ordinarily be in-synch (i.e. zero crossings will coincide) at the exact same moment in time every 250 nanoseconds. This means the present invention is able to synchronize transmit and receive side once every micro second (once per four patterns) in a preferred embodiment.

In a preferred embodiment, a phase difference is injected into one of the two signals which will throw the timing off such that the signals will no longer zero cross every 250 nanoseconds—i.e. the signals will no longer be in phase every 250 nanoseconds. This, along with a valid transmitter ID code, notifies the mobile receiving unit that a new transmission is being received from another ground station. As explained earlier, the timing at which the phase difference is introduced into the RF carrier signals is different for every transmission model so no two models within a single cell will be transmitting at the same time. The mobile receiving unit, upon recognizing a new transmission, will then extract the digital data pattern which was generated by the data modem in the Base/Slave Model and which was mixed with one of the RF carrier signals at the time of transmission. The content of the data pattern is described below.

As explained above, at a predefined time (precise time of day plus time interval stored as data in the transmission units as described above) the Base or Slave Model will transmit a data pattern to the receiving unit (the cell phone or PDA) which can be used by the receiving unit to determine its exact location. The data pattern includes:

a. A start of transmission code which indicates a new data pattern is being transmitted/received. This is preferably one byte in length.

b. A transmitter identification code which identifies the Model from which the signal was transmitted. This will preferably be a maximum of two bytes.

c. The transmit time stamp which identifies the transmit time at which the data pattern was transmitted. This transmit time stamp is preferably a maximum of three bytes which will allow transmission times to be determined in hundredths of a second.

d. The location of the transmitting unit, plus or minus one foot. For example: If latitude and longitude are expressed in minutes times 6,076 (one foot of latitude at the equator), it would require 3 bytes for latitude and 3 bytes for longitude to provide a resolution of plus or minus five feet. Otherwise, 4 bytes would be required for each measurement. In a preferred embodiment, 4 bytes will be used.

e. A synchronization pattern or time stamp. Example; 1 1 0 1 0 1 1 1. In this case, the receiving unit would synchronize on the raising edge of the 4th bit to establish the time of arrival of the signal from the previously determined transmitter.

f. A 16-bit CRC error checking code.

This data transmission signal pattern (if not altered) totals seventeen bytes. The time required to transmit this signal would be: (the most conservative estimate assuming 10 unit code and 56,000 bit per second data transmission rate), less than one one-hundreth of a second. Some delay may be required between the end of the transmission of one unit and the start of the next transmission. This delay is yet to be determined.

For those time distribution transmitters that receive their time of day correction data from another time distribution transmitter—i.e. Slave Models, it will be necessary to program a correction factor into the unit in order to subtract the delays that are encountered between the Base Model transmitter and the local Slave Model receiver. These delays include propagation time between sites, antenna and antenna cable delays and delays introduced by the local receiver within the Base Model itself. Since both units—i.e. Base and Slave Models, are at fixed locations, delays should be constant after initial installation.

Steps for Determining Location of Mobile Receiving Unit

The value of the invention is realized when it is incorporated into a network and used with receiving units implemented in various hand held mobile units such as cell phones and other devices such as Personal Digital Assistants (PDA's) or devices like the 3Com Palm Pilot. Each receiving unit will require an internal clock with a short-term instability on the order of less than two (2) nanoseconds per second, depending on the desired accuracy of the receiving unit. This internal clock will provide internal (mobile) time of day information, but because it is a moving device, this time of day may not be sufficiently accurate to determine the distance (time) from a Base Unit or Slave Unit to the receiving unit. However, it will be useful in determining the differences in the distance (propagation times in nanoseconds) between signals that are received from different transmitting sites (i.e. different Base and Slave Units) and received within a short period of time (on the order of millisecond).

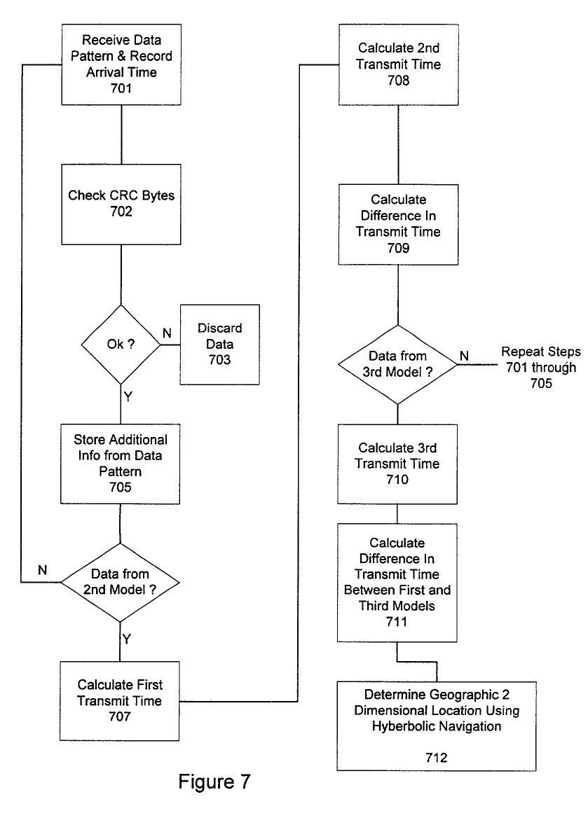

FIG. 7 illustrates the steps involved in determining the exact 2 dimensional (longitude and latitude) geographic location of a mobile receiving unit. As shown, a receiving unit implemented in the mobile device receives the two RF carrier signals over dedicated receiving channels in the cell phone mobile, PDA. Upon recognizing a phase shift between the two RF carrier signals and the beginning of a new transmission, the receiving unit receives and records a data signal from at a first transmitter (Base and/or Slave Model) and records the time of arrival of the leading edge of the synchronizing bit for the data signal based on the receiving units internal time of day clock 701. The receiving unit also checks the CRC bytes in the data signal to assure that all of the data was received without transmission error 702. If a data transmission error occurred, all of the data is discarded 703. If the CRC determines that the data was received without transmission error, the receiving unit stores the following additional information 705:

The transmitter identification code of the sending transmitter,

The time of transmission as determined by the sending transmitter and entered in the data signal,

The location of the sending transmitter.

The receiving unit continues to monitor the two dedicated RF channels until it recognizes another phase shift indicating a second transmission from a second Base/Slave Model. The receiving unit then repeats the process of extracting and recording the digital data received from the second model (Base Unit or Slave Model) 706.

Next, the receiving unit calculates the estimated transmission time from the first transmitting unit to the mobile receiving unit 707. Let us call the Sending Time at which the first data signal was transmitted from the first transmitter (Base or Slave Model) T_{B1} (this information is contained in the data pattern as explained above) and let us refer to the Receiving Time (local time as determined by the time of day clock in the receiving unit) as T_{L} this is the time of arrival of the leading edge of the synchronizing bit for the data pattern as recorded by the receiving unit and based on the receiving units internal time of day clock. Therefore the estimated transmission time for the signal to travel from the first Base/Slave Model to the receiving unit is=T_{L}−T_{B1}.

The receiving unit then calculates the estimated transmission time from the second transmitting unit to the mobile receiving unit 708. Let us call the Sending Time at which the second data signal was transmitted from the second transmitter (Base or Slave Model) T_{B2} (once again this information will be contained in the data pattern received from the second Base/Slave Model) and let us refer to the Receiving Time (local time as determined by the time of day clock in the receiving unit) as T_{L}. Therefore the estimated transmission time for the signal to travel from the second Base/Slave Model to the mobile is=T_{L}−T_{B2}.

Finally, the receiving unit calculates the difference in the transmission time from the first transmitter (Base/Slave Model) to the mobile receiving unit and from the second transmitter to the mobile receiving unit 709, this difference is

$$= {T}_{L} - {T}_{B1} - ( {T}_{L} - {T}_{B2} ) \\ = {T}_{L} - {T}_{B1} - {T}_{L} + {T}_{B2} \\ = - {T}_{B1} + {T}_{B2} \\ = {T}_{B2} - {T}_{B1}$$

The receiving unit then determines if it has received data from at least three transmission models. Since it has not, the process is repeated between the mobile receiving unit and a third Base/Slave Model—i.e. steps 701 through 705 are repeated for the data pattern from a third Base/Slave Model and, accordingly, data is received from a third Base/Slave Model. Once again the CRC is checked to ensure all data was properly received from the third Base/Slave Model. If all data was properly received, then the transmit time from the third transmitting unit to the mobile receiving unit is calculated. Finally, the difference in transmit time from the third Base Slave Model to the receiving unit is determined 710 and the difference in transmission time between the first and third units is determined 711.

Now, using the time difference of transmission time between the mobile receiving unit and Base Units 1 & 2, the time difference of transmission time between the mobile receiving unit and Base Units 1 & 3, and the known fixed locations of Base Units 1, 2, & 3, it is possible for the receiving unit to determine its geographic location using the technique known in the art as hyperbolic navigation 712. This calculated result is independent of the time of day accuracy of the clock in the mobile receiving unit, and is dependent solely upon the accuracy of the time elapsed between readings.

It is understood that FIG. 7 shows the steps for determining a two dimensional (longitude and latitude) location of the receiving unit. If the elevation of the receiving unit is also needed, i.e. for three-dimensional geographic location. A data pattern from a fourth transmission Base/Slave Model must be received, the transmission time must be computed, and the difference in transmission time between of the other models and the fourth model must be computed in order to determine the coordinates of a fourth (vertical or elevation) which can be used to determine the elevation of the receiving unit.

Network Performance Monitoring & Self Calibration

In a preferred embodiment of the present invention, the system is capable of automatic performance monitoring of the entire local time distribution network and automatic calibration of any Slave Model. Since all of the Base/Slave Models in the system are at fixed locations, the physical distance between Models. Moreover, the electrical distance, as measured by the delay caused by radio transmission, can be calculated and measured directly. Since the speed/velocity of a radio wave signal is approximately one foot per nanosecond, then the measured electrical distance (as determined by the delay in the radio signal) is equal to the transmit time multiplied by the speed/velocity. If the measured physical distance is equal to the measured electrical distance, then the system can be assumed to be correctly calibrated and operating properly. If there is a difference between the two measurements, the system will need to be calibrated.

The determination of the physical distance and the electrical distance (the distance as determined by the radio transmission time from a GPS equipped site to the Slave Model site) is only slightly complicated. The process for determining the electrical distance is as follows:

1) A Slave Model is assembled (including all of the antenna equipment and transmission line that will be used in the final installation) at a temporary location. This temporary location must have a line-of-sight path to a site that is equipped with a GPS receiver—i.e. to a Base Model. The precise physical distance between the sites must be known or measured.

2) The time-of-day clock in the Slave Model is then synchronized with the time-of-day clock in the associated Base Model. A portable frequency standard may be used for this task.

3) The electrical distance is then measured by sending a signal to from the Base Model to the Slave Model, measuring the transmit time, multiplying the transmit time by the speed/velocity of the radio wave signal and comparing this distance with the actual known physical distance between the two models.

4) The difference between the physical distance and the electrical distance is then converted into a time offset—i.e. the delay associated with the transmission, and this time offset is then input to the Slave Model. The entire process is repeated and the time offset is continually adjusted until the measured physical distance agrees with the measured electrical distance less any time offset. The final time offset becomes the time-of-day correction factor for the Slave Model. This correction factor is intended to compensate for all internal (equipment) and external (antenna and antenna cable) delays associated with transmission between the two models.

5) The Slave Model is then moved to its intended installation site and turned-on. Next, the time-of-day correction factor is adjusted to account for the increased electrical distance from that used for calibration to that which exists in the actual radio path. This adjusted time-of-day correction factor is programmed into the Slave Model.

6) The Slave Model now receives the time-of-day from the Base Model, applies the adjustment factor, and if all is correct, the Slave Model has time-of-day that is traceable to the GPS receiver.

7) The Slave Model then commences normal operation. Next, the Base Model receives the time-of-day signal from the newly installed Slave Model and calculates the electrical distance. If the electrical distance from Base Model to Slave Model is equal to the electrical distance from the Slave Model to the Base Model and both agree with the measured physical distance, the calibration process is complete.

If the error is small, an adjustment to the time-of-day correction factor may be considered. If the measured electrical distance in both directions is greater than the physical distance, the cause is probably the result of a reflected signal path rather than a direct path. In this case, an adjustment in the time-of-day correction factor is the proper remedy. If none of the above apply, the calibration process should be repeated or the antenna location changed. As a last resort, the time-of-day clock in the Slave Model can be set using a portable primary reference standard and the value of the time-of-day correction factor determined by adjusting until the electrical path length is equal in both directions. Once the value of the time-of-day correction factor is determined, it should remain the same unless new construction results in an electrical path length change.

8) If the Slave Model is within communication range of more than one Base Model or even another previously calibrated Slave Model, the process is repeated with each unit. The accuracy and reliability of the network is improved with each additional path that is included in the calibration process. One may expect network performance improvement as individual links become networks and networks become webs.

In a preferred embodiment, all Base Models should be programmed to monitor all other Base Models and Slave Models that are within reliable communications range and to report any consistent measurement errors. By using this process, the network monitors itself and reports internal problems or errors without site visits or further calibration.

Receiving Units

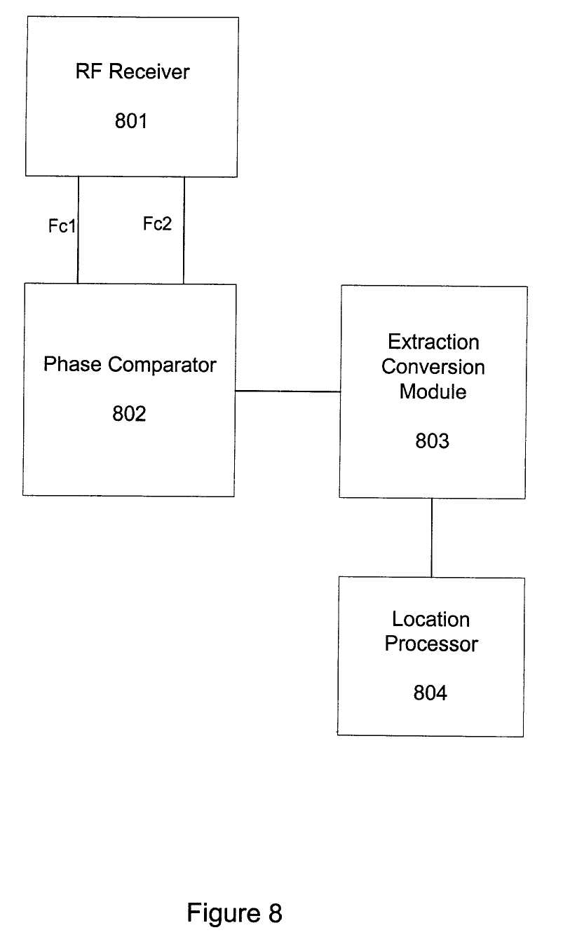

As explained earlier, a receiving unit is preferably implemented in a mobile handheld device such as a digital cellular phone or FDA. FIG. 8 illustrates functional blocks for the internal components of a receiving unit. As shown, each receiving unit will be equipped with an RF Receiver 801 for receiving the RF signals from the Base/Slave Models over the two dedicated RF channels. The receiving unit will also include a Phase Comparator 802 coupled to the RF Receiver which samples the two RF channels and detects differences in the phase between the two signals in order to determine when a new transmission is being received.

The receiving unit also preferably includes an Extraction/Conversion module 803 which will preferably extract the analog signal representing the data pattern from the RF signal once a new transmission is detected, and will convert the analog data pattern into a seventeen byte digital signal. As set forth above, the data pattern includes:

a. A start of transmission code which indicates a new data pattern is being transmitted/received. This is preferably one byte in length.

b. A transmitter identification code which identifies the Model from which the signal was transmitted. This will preferably be a maximum of two bytes.

c. The transmit time stamp which identifies the transmit time at which the data pattern was transmitted. This transmit time stamp is preferably a maximum of three bytes which will allow transmission times to be determined in hundredths of a second.

d. The location of the transmitting unit, plus or minus one foot. For example: If latitude and longitude are expressed in minutes times 6,076 (one foot of latitude at the equator), it would require 3 bytes for latitude and 3 bytes for longitude to provide a resolution of plus or minus five feet. Otherwise, 4 bytes would be required for each measurement. In a preferred embodiment, 4 bytes will be used.

e. A synchronization pattern or time stamp. Example; 1 1 0 1 0 1 1 1. In this case, the receiving unit would synchronize on the raising edge of the 4th bit to establish the time of arrival of the signal from the previously determined transmitter.

f. A 16-bit CRC error checking code.

The receiving unit will preferably be equipped with a memory or it may use memory already existent within the mobile handheld device in which it is implemented—i.e. the memory in the cell phone or the PDA, in order to store this information.

Finally, the receiving unit will include a Location Processor and pre-installed software 804 which includes instructions for determining either the two or three dimensional position of the receiving module (and the handheld device in which it is implemented) using Hyperbolic Navigation. It is understood that the receiving unit may optionally use a processor already resident in the handheld device—i.e. in the cellular phone or PDA and will not require an additional processor for calculating position.

The above description is intended to illustrate the operation of the preferred embodiments of the present invention and is not meant to limit the scope of the invention. The scope of the invention is to be limited only by the following claims. From the above discussion, many variations will be apparent to one skilled in the art that would yet be encompassed by the spirit and scope of the invention.

What is claimed is:

1. A method for determining the location of a receiving unit comprising the steps of:
receiving a first RF signal having a known transmission velocity and containing a first data pattern including a first transmit time stamp at which the RF signal was transmitted from a first ground unit having a first fixed location;
recording a first arrival time of said first RF signal;
receiving a second RF signal having a known transmission velocity and containing a second data pattern including a second transmit time stamp at which the RF signal was transmitted from a second ground unit having a second fixed location;
recording a second arrival time of said second RF signal;
receiving a third RF signal having a known transmission velocity and containing a third data pattern including a third transmit time stamp at which the RF signal was transmitted from a third ground unit having a third fixed location;
recording a third arrival time of said third RF signal; and
determining the location of the receiving unit using the first transmit time stamp, the first fixed location, the first arrival time, the known transmission velocity of said first RF signal, the second transmit time stamp, the second fixed location, the second arrival time, the known transmission velocity of said second RF signal, the third transmit time stamp, the third fixed location, the third arrival time, and the known transmission velocity of said third RF signal.

2. The method of claim 1, wherein the step of determining the location of the receiving unit comprises:
calculating a first transmit time from the first fixed location to the receiving unit;
calculating a second transmit time from the second fixed location to the receiving unit; and
calculating a third transmit time from the third fixed location to the receiving unit.

3. The method of claim 2, further comprising:
determining a first time difference between the first transmit time and the second transmit time; and
determining a second time difference between the first transmit time and the third transmit time.

4. The method of claim 3 further comprising:
calculating a first possible location hyperbola which represents a series of possible locations of the receiving unit between the first fixed location and the second fixed location as determined by the first time difference between the first transmit time and the second transmit time and the speed of an RFradio signal;
calculating a second possible location hyperbola which represents a series of possible locations of the receiving unit between the first fixed location and the third fixed location as determined by the second time difference between the first transmit time and the third transmit time and the speed of an RF radio signal; and
determining a fixed location point where the first possible location hyperbola and the second possible location hyperbola intersect, said fixed location point representing the location of the receiving unit.

5. A series of data patterns received by a receiving unit and used by the receiving unit for determining its geographic location, the data patterns comprising:
a first data pattern including fixed location information about a first fixed location from which the data pattern was transmitted, transmit time stamp information about a time of transmission of the data pattern, and a synchronization pattern upon which the receiving unit will synchronize in order to establish the time of arrival of the first data pattern;
a second data pattern including fixed location information about a second fixed location from which the second data pattern was transmitted, transmit time stamp information about a time of transmission of the second data pattern, and a synchronization pattern upon which the receiving unit will synchronize in order to establish the time of arrival of the second data pattern; and
a third data pattern including fixed location information about a third fixed location from which the third data pattern was transmitted, transmit time stamp information about a time of transmission of the third data pattern, and a synchronization pattern upon which the receiving unit will synchronize in order to establish the time of arrival of the third data pattern.

6. The series of data patterns of claim 5, further comprising:
a fourth data pattern including fixed location information about a fourth fixed location from which the fourth data pattern was transmitted, transmit time stamp information about a time of transmission of the fourth data pattern, and a synchronization pattern upon which the receiving unit will synchronize in order to establish the time of arrival of the fourth data pattern.

7. A system for determining the location of a receiving unit comprising:
a base time transmitter having a first fixed location for transmitting a first RF signal containing a first data pattern including a first transmit time stamp to the receiving unit;
a first slave transmitter having a second fixed location for transmitting a second RF signal containing a second data pattern including a second transmit time stamp to the receiving unit; and
a second slave transmitter having a third fixed location for transmitting a third RF signal containing a third data pattern including a third transmit time stamp to the receiving unit.

8. The system of claim 7, wherein the base time transmitter, the first slave transmitter and the second slave transmitter all transmit RF signals at the same frequency but at different points in time such that the base time transmitter transmits next, and the first slave transmitter transmits second, and the second slave transmitter transmits last.

9. The system of claim 7, wherein the base time transmitter includes an oscillator clock which generates a TIME OF DAY signal which is calibrated using a direct GPS signal and used for setting the first transmit time stamp.

10. The system of claim 9, wherein the first slave transmitter includes an oscillator which is calibrated using the TIME OF DAY signal generated by the base time transmitter and used for setting the second transmit time stamp.

11. The system of claim 10, wherein the second slave transmitter includes an oscillator which is calibrated using the TIME OF DAY signal generated by the base time transmitter and used for setting the third transmit time stamp.

12. The system of claim 7, wherein the receiving unit comprises:
a receiver for receiving the first data pattern and recording a first arrival time of said first data pattern, receiving the second data pattern and recording a second arrival time of said second data pattern, and receiving the third data pattern and recording a third arrival time of said third data pattern; and
a location calculation module for determining the location of the receiving unit using the first transmit time stamp, first fixed location, first arrival time, second transmit time stamp, second fixed location, second arrival time, third transmit time stamp, third fixed location and third arrival time.

13. A base time distribution transmitter having a fixed ground location and comprising:
a receiver for receiving precise time of day information from a GPS satellite; and
a transmitter for transmitting the precise time of day information to a receiving unit via a dedicated RF frequency channel at preprogrammed intervals in time, thereby providing the equivalent of a GPS signal to the receiving unit in areas where GPS coverage is otherwise unavailable.

14. The base time distribution transmitter of claim 13, further comprising a timing control logic unit which determines and controls the preprogrammed intervals in time at which the precise time of day information is transmitted to the receiving unit via the dedicated RF frequency.

15. A mobile receiving unit implemented in a cellular phone comprising:
a receiver for receiving RF signals each containing data patterns from a plurality of ground based transmission models, each model having a known fixed location;
a memory for storing the data patterns from each ground based transmission model in the plurality and recording the time each data pattern was received;
a calculation model for determining the exact geographic location of the mobile receiving unit once at least three data patterns have been received from three different ground based transmission models.

16. The mobile receiving unit of claim 15, further comprising:
an internal clock source;
a receiver for receiving the equivalent of a GPS signal from a base model transmitter located at a fixed ground location, the equivalent of the GPS signal being used for calibrating the internal clock source.
